(19) United States
(12) Patent Application Publication
(10) Pub. No.: US 2011/0242949 A1
(43) Pub. Date: Oct. 6, 2011

(54) SIGNAL PROCESSING CIRCUIT AND OPTICAL DISC REPRODUCING DEVICE

(75) Inventors: Keisuke KIKUMOTO, Kyoto (JP); Takeshi ODA, Osaka (JP); Yoshinori OKA, Kyoto (JP)

(73) Assignee: PANASONIC CORPORATION, Osaka (JP)

(21) Appl. No.: 13/160,850

(22) Filed: Jun. 15, 2011

Related U.S. Application Data
(63) Continuation of application No. PCT/JP2009/005442, filed on Oct. 19, 2009.

(30) Foreign Application Priority Data
Dec. 25, 2008 (JP) 2008-331364

(51) Int. Cl. G11B 21/08

(52) U.S. Cl. 369/30.03; G9B/21.012

(57) ABSTRACT

The signal processing circuit in the present invention includes a tracking polarity determination unit configured to determine the polarity when tracking control is performed on an optical disc, on which a wobble is formed, the tracking polarity determination unit including: a binarized wobble signal generation unit configured to generate a wobble signal according to the shape of the wobble, and to generate a binarized wobble signal; a characteristic quantity measurement unit configured to measure the characteristic quantity of the binarized wobble signal generated by the binarized wobble signal generation unit; a determination unit configured to determine whether or not the characteristic quantity of the binarized wobble signal measured by the characteristic quantity measurement unit indicates a predetermined characteristic; and a polarity determination unit configured to determine the polarity by the result of the determination by the determination unit.

### CROSS REFERENCE TO RELATED APPLICATION

This is a continuation application of PCT application No. PCT/JP2009/005442 filed on Oct. 19, 2009, designating the United States of America.

### BACKGROUND OF THE INVENTION

(1) Field of the Invention

The present invention relates to a signal processing circuit and an optical disc reproducing device, and particularly, to a signal processing circuit and an optical disc reproducing device that determine a tracking control polarity when information recorded in an optical disc is reproduced.

(2) Description of the Related Art

A disc-like recording medium referred to as a CD (Compact Disc), a DVD (Digital Versatile Disc), or a BD (Blu-ray Disc) records information by forming a recess called a pit, or a chemical change in a phase transition film (hereinafter referred to as a mark) in a spiral shape from the inner circumference to the outer circumference. An optical disc reproducing device using the disc-like recording medium (hereinafter referred to as an optical disc) irradiates the optical disc with a laser beam, and determines the existence of a pit or a mark from the quantity of reflected laser beam to reproduce the information.

In order to read the pit or the mark, the optical disc reproducing device performs rotation control for rotating the optical disc at a predetermined number of rotation, focus control for controlling the focal position of the laser on the recording surface of the optical disc, and tracking control for properly scanning the laser beam on the pits recorded in a spiral shape.

As a recording system for an optical disc in which marks or pits indicating information are recorded in a spiral shape, there exist two recording systems: the on-groove system and the in-groove system.

FIG. 14 is a diagram for illustrating the characteristics of the on-groove system and the in-groove system. The diagram above in FIG. 14 is for illustrating the characteristic of the on-groove system, and the diagram below in FIG. 14 is for illustrating the characteristic of the in-groove system.

In both of the on-groove and in-groove systems, information (data) is recorded by forming, for example, a pit 705 on a groove 704 which is formed in a spiral shape on an optical disc and has a wobble as address information.

The groove 704 is a recess formed on the optical disc, and information (data) is recorded in the recess. The groove 704 is normally (in the case of the on-groove system) in a convex shape as viewed from the direction of incidence of the laser beam (hereinafter referred to as a plane of incidence of the beam). A land 703 is an area between the groove 704 and the adjacent groove 704. A wobble is winding (meandering) formed with the groove so as to wind it with a constant amplitude and a spatial frequency.

As shown in FIG. 14, in the on-groove system, the groove 704 in which the pit 705 is formed is in a convex shape as viewed from the plane of incidence of the beam, while in the in-groove system, the groove 704 in which the pit 705 is formed is in a concave shape as viewed from the plane of incidence of the beam. Accordingly, the case where tracking control is performed on the groove 704 based on the on-groove system, and the case where tracking control is performed on the groove 704 based on the in-groove system involve opposite polarities of the tracking error signals for performing tracking control.

FIG. 15 is a diagram for illustrating a scan of the track of a disc in which data is recorded in accordance with the on-groove system. FIG. 15 shows the manner how the beam spot of a laser beam scans the track of an optical disc in which data is recorded in accordance with the on-groove system. The beam spot A shows the spot when tracking control is performed with the tracking polarity of the on-groove system, while the beam spot B shows the spot when tracking control is performed with the tracking polarity of the in-groove system.

In FIG. 15, in the case where the beam spot A scans the track having the groove 704 in a convex shape as viewed from the plane of incidence of the beam, the wobble and the information (data) on the track can be read correctly because the pit 705 and the wobble are recorded in the groove 704. On the other hand, in the case where the beam spot B scans the track having the land 703, the wobble and the information (data) on the track cannot be read correctly because the pit 705 and the wobble are not recorded in the land 703.

On the contrary, for the disc in which data is recorded in accordance with the in-groove system, even when the beam spot A scans the track having the land 703 in a convex shape as viewed from the plane of incidence of the beam, the wobble and the information (data) on the track cannot be read correctly because the pit 705 and the wobble are not recorded in the land 703. However, when the beam spot B scans the track having the groove 704 in a concave shape as viewed from the plane of incidence of the beam, the wobble and the information (data) on the track can be read correctly because the pit 705 and the wobble are recorded in the groove 704.

That is to say, for the disc in which data is recorded in accordance with the on-groove system, in the case where the control polarity is matched to the on-groove system, the wobble and the information (data) on the track can be read correctly because the pit 705 is recorded in the groove 704. However, in the case where the control polarity is matched to the in-groove system, the wobble and the information (data) on the track cannot be acquired correctly from the track.

For this reason, when an optical disc is reproduced, it is necessary to determine whether the optical disc is in accordance with the on-groove system or the in-groove system, and to select the control polarity matched to the optical disc.

According to the standard of an optical disc media such as a DVD-R or a DVD-RW which has been the mainstream of the conventional optical disc for recording so far, data is supposed to be recorded in accordance with the on-groove system. For this reason, for the optical disc reproducing device, tracking control has been possible without particularly considering the polarity of the tracking control.

However, in recent years, low-price recording disc called BD-R LTH (LOW TO HIGH) disc has been developed. And it is expected that BD-R LTH disc will be widely distributed in the market in the near future. According to the standard of the BD-R LTH disc, data is recorded thereon in accordance with the in-groove system, thus when other non-LTH BD-R disc is reproduced, the polarity of the tracking control needs to be reversed to perform reproduction control. Therefore, in the case where the optical disc reproducing device is attempted to be reproduced using incorrect polarity of the tracking control, the optical disc reproducing device performs tracking control on the track without any mark being formed, thus desired information (data) cannot be reproduced.

For this problem, a proposal related to the determination whether a recording system is either the on-groove or the in-groove system has been made (for example, see WO 2007/040173, hereinafter referred to as Patent Reference 1). The proposal is described in the following.

FIG. 16 is a block diagram showing the conventional configuration of an optical disc reproducing device for identifying the recording system of an optical disc.

An optical disc reproducing device 900 shown in FIG. 16 includes a tracking polarity determination unit 901, an optical disc 902, an optical pickup unit 903, a push-pull signal generation unit 904, a servo filter 909, and a drive unit 911. Also, the tracking polarity determination unit 901 includes a wobble signal generation unit 905, an amplitude measurement unit 906, a determination unit 907, and a polarity determination unit 908.

In the optical disc reproducing device 900, tracking is performed on each of the on-groove and the in-groove of the optical disc 902, and the amplitudes of respective binarized wobble signals are measured. From the measurement result, the tracking polarity is determined by identifying the groove with a greater amplitude as the correct track.

### SUMMARY OF THE INVENTION

However, in the method proposed in Patent Reference 1, in order to determine whether the in-groove system or the on-groove system is used for recording on an optical disc loaded to the optical disc reproducing device, the amplitude information of the binarized wobble signal is obtained in each of the on-groove and the in-groove. That is to say, in order to determine whether the in-groove system or the on-groove system is used for recording, the binarized wobble signal needs to be measured twice. Furthermore, during the two measurements, for example, in order to move from the on-groove to the in-groove, additional time is required to stop tracking control once, then apply tracking control to the in-groove again. After all, more time is required for the determination.

Now, the present invention has been made to solve the above-mentioned problem, and it is an object of the present invention to provide a signal processing circuit and an optical disc reproducing device that can reduce the time taken to identify the recording system of an optical disc.

In order to achieve the above-mentioned object, the signal processing circuit according to the present invention includes: a tracking polarity determination unit configured to determine a polarity when tracking control is performed on an optical disc having a groove track and a land track, on which a frequency-modulated or phase-modulated wobble is formed to indicate address information on the groove track in which data is recorded, the tracking polarity determination unit including: a binarized wobble signal generation unit configured to generate a wobble signal according to a shape of the wobble, and to generate a binarized wobble signal based on whether or not a value of the wobble signal exceeds a threshold value; a characteristic quantity measurement unit configured to measure a characteristic quantity of the binarized wobble signal generated by the binarized wobble signal generation unit; a determination unit configured to determine whether or not the characteristic quantity of the binarized wobble signal measured by the characteristic quantity measurement unit indicates a predetermined characteristic; and a polarity determination unit configured to determine the polarity by a result of the determination by the determination unit.

Accordingly, only a single measurement of the binarized wobble signal for the track allows the recording system of an optical disc to be identified as the on-groove system or the in-groove system from the characteristic quantity of the measured binarized wobble signal. Thereby, a signal processing circuit that can reduce the time taken to identify the recording system of an optical disc can be achieved.

Preferably, the characteristic quantity measurement unit is configured to measure a period of the binarized wobble signal, as the characteristic quantity of the binarized wobble signal.

The characteristic quantity measurement unit may measure a duty of the binarized wobble signal as the characteristic quantity of the binarized wobble signal, the duty being a ratio between a time interval during which the binarized wobble signal has a high-level value in a predetermined period and another time interval during which the binarized wobble signal has a low-level value in the predetermined period.

Also, the characteristic quantity measurement unit may measure, as the characteristic quantity of the binarized wobble signal, a longest or a shortest time interval during which the binarized wobble signal has a high-level value within a predetermined time.

Also, the characteristic quantity measurement unit may measure, as the characteristic quantity of the binarized wobble signal, a longest or a shortest time interval during which the binarized wobble signal has a low-level value within a predetermined time.

Also, the characteristic quantity measurement unit may measure, as the characteristic quantity of the binarized wobble signal, the number of rising edge within a predetermined time or the number of falling edge within a predetermined time, the rising edge each indicating a moment when the binarized wobble signal changes to a high-level value, and the falling edge each indicating a moment when the binarized wobble signal changes to a low-level value.

In order to achieve the above-mentioned object, the optical disc reproducing device according to the present invention includes: an optical pickup unit configured to read information needed to perform tracking control, from an optical disc having a groove track and a land track, on which a frequency-modulated or phase-modulated wobble is formed to indicate address information on the groove track in which data is recorded; a tracking polarity determination unit configured to determine a polarity when tracking control is performed, from the information read by the optical pickup unit; and a drive unit configured to perform tracking control of the optical pickup unit by a control signal generated based on the polarity of tracking control determined by the tracking polarity determination unit, the tracking polarity determination unit including: a binarized wobble signal generation unit configured to generate a wobble signal according to a shape of the wobble from the information read by the optical pickup unit, and to generate a binarized wobble signal based on whether or not the value of the wobble signal exceeds a threshold value; a characteristic quantity measurement unit configured to measure a characteristic quantity of the binarized wobble signal generated by the binarized wobble signal generation unit; a determination unit configured to determine whether or not the characteristic quantity of the binarized wobble signal measured by the characteristic quantity measurement unit indicates a predetermined characteristic; and a polarity determination unit configured to determine the polarity by a result of the determination by the determination unit.

Preferably, the characteristic quantity measurement unit may measure a period of the binarized wobble signal, as the characteristic quantity of the binarized wobble signal.

The characteristic quantity measurement unit may measure a duty of the binarized wobble signal as the characteristic quantity of the binarized wobble signal, the duty being a ratio between a time interval during which the binarized wobble signal has a high-level value in a predetermined period and another time interval during which the binarized wobble signal has a low-level value in the predetermined period.

Also, the characteristic quantity measurement unit may measure, as the characteristic quantity of the binarized wobble signal, a longest or a shortest of time during which the binarized wobble signal has a high-level value within a predetermined time.

Also, the characteristic quantity measurement unit may measure, as the characteristic quantity of the binarized wobble signal, a longest or a shortest time interval during which the binarized wobble signal has a low-level value within a predetermined time.

Also, the characteristic quantity measurement unit may measure, as the characteristic quantity of the binarized wobble signal, the number of rising edges within a predetermined time or the number of falling edges within a predetermined time, the rising edges each indicating a moment when the binarized wobble signal changes to a high-level value, and the falling edges each indicating a moment when the binarized wobble signal changes to a low-level value.

In addition, the present invention can be achieved not only as a device, but also as an integrated circuit including the processing means provided in the device, or as a method including the steps which are defined by the operation of the processing means provided with the device.

According to the present invention, a signal processing circuit and an optical disc reproducing device that can reduce the time taken to identify the recording system of an optical disc can be achieved.

Specifically, with the information of either one of the on-groove or the in-groove, identification of the recording system can be achieved, thus the polarity can be determined only by measuring the binarized wobble signal once. Accordingly, it is possible to reduce the time taken to determine whether data on an optical disc is recorded in accordance with the in-groove system or the on-groove system.

### FURTHER INFORMATION ABOUT TECHNICAL BACKGROUND TO THIS APPLICATION

The disclosure of Japanese Patent Application No. 2008-331364 filed on Dec. 25, 2008 including specification, drawings and claims is incorporated herein by reference in its entirety.

The disclosure of PCT application No. PCT/JP2009/005442 filed on Oct. 19, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing the configuration of an optical disc reproducing device for identifying the recording system of an optical disc, in the present invention;

FIG. 2 is a flowchart for illustrating the operation of a tracking polarity determination unit in the present invention;

FIG. 3 is a block diagram showing the configuration of an optical disc reproducing device for identifying the recording system of an optical disc, in Embodiment 1;

FIG. 4A is a diagram for illustrating a method of determining whether the characteristic quantity of a binarized wobble signal indicates a predetermined characteristic quantity;

FIG. 4B is a diagram for illustrating the method of determining whether the characteristic quantity of a binarized wobble signal indicates a predetermined characteristic quantity;

FIG. 5 is a flowchart for illustrating the operation of the tracking polarity determination unit in Embodiment 1;

FIG. 6 is a block diagram showing the configuration of an optical disc reproducing device for identifying the recording system of an optical disc, in Embodiment 2;

FIG. 7A is a diagram for illustrating the method of determining whether the characteristic quantity of a binarized wobble signal indicates a predetermined characteristic quantity;

FIG. 7B is a diagram for illustrating the method of determining whether the characteristic quantity of a binarized wobble signal indicates a predetermined characteristic quantity;

FIG. 8 is a flowchart for illustrating the operation of a tracking polarity determination unit in Embodiment 2;

FIG. 9 is a block diagram showing the configuration of an optical disc reproducing device for identifying the recording system of an optical disc, in Embodiment 3;

FIG. 10A is a diagram for illustrating the method of determining whether the characteristic quantity of a binarized wobble signal indicates a predetermined characteristic quantity;

FIG. 10B is a diagram for illustrating the method of determining whether the characteristic quantity of a binarized wobble signal indicates a predetermined characteristic quantity;

FIG. 11 is a block diagram showing the configuration of an optical disc reproducing device for identifying the recording system of an optical disc, in Embodiment 4;

FIG. 12A is a diagram for illustrating a method of determining whether the characteristic quantity of a binarized wobble signal indicates a predetermined characteristic quantity;

FIG. 12B is a diagram for illustrating a method of determining whether the characteristic quantity of a binarized wobble signal indicates a predetermined characteristic quantity;

FIG. 13 is a block diagram showing the configuration of an optical disc reproducing device for identifying the recording system of an optical disc, in Embodiment 5;

FIG. 14 is a diagram for illustrating the characteristic of the on-groove system and the in-groove system;

FIG. 15 is a diagram for illustrating a scan of the track in the on-groove system; and

FIG. 16 is a block diagram showing the conventional configuration of an optical disc reproducing device for identifying the recording system of an optical disc.

### DESCRIPTION OF THE PREFERRED EMBODIMENTS

Hereinafter, the embodiments of the present invention are described with reference to the drawings.

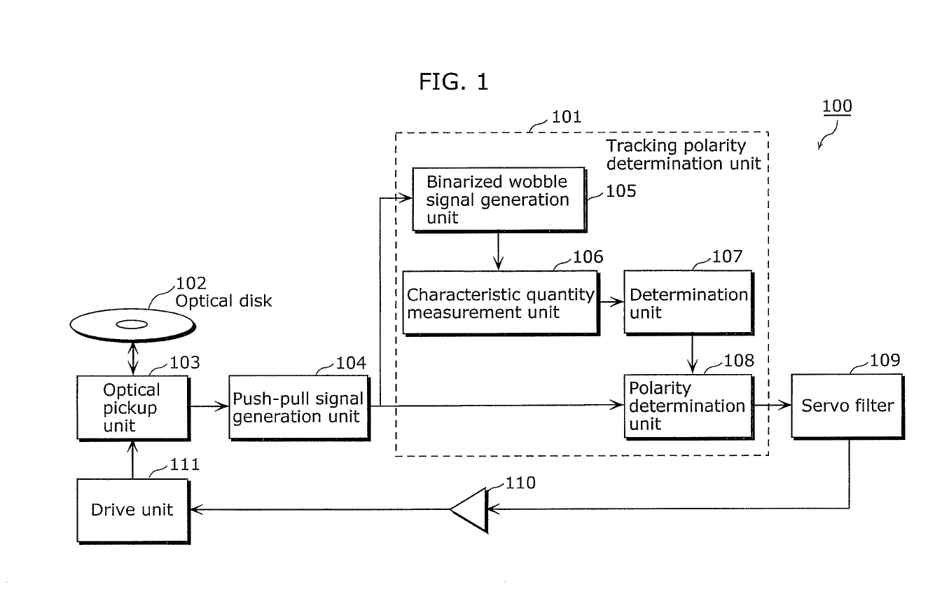

FIG. 1 is a block diagram showing the configuration of an optical disc reproducing device for identifying the recording system of an optical disc, in the present invention.

An optical disc reproducing device 100 shown in FIG. 1 includes a tracking polarity determination unit 101, an optical disc 102, an optical pickup unit 103, a push-pull signal generation unit 104, a servo filter 109, and a drive unit 111. Also, the tracking polarity determination unit 101 includes a binarized wobble signal generation unit 105, a characteristic quantity measurement unit 106, a determination unit 107, and a polarity determination unit 108.

The optical disc 102 has a groove 704 and a land 703, and frequency-modulated or phase-modulated wobble is formed to indicate absolute address information on the track of the groove 704 in which information (data) is recorded. Also, the optical disc 102 may be recorded in accordance with the on-groove system, or may be recorded in accordance with the in-groove system. In the case where the optical disc 102 is recorded in accordance with the on-groove system, the track of the groove 704 in which information (data) is recorded is in a convex shape as viewed from the plane of incidence of the beam. On the contrary, in the case where the optical disc 102 is recorded in accordance with the in-groove system, the track of the groove 704 in which information (data) is recorded is in a concave groove as viewed from the plane of incidence of the beam.

The optical pickup unit 103 converts the reflection amount of the laser beam with which the optical disc 102 is irradiated, into voltage information, then outputs it to the push-pull signal generation unit 104. The optical pickup unit 103 is controlled by the drive unit 111.

The push-pull signal generation unit 104 generates a push-pull signal from the reflected beam from the optical disc 102. That is to say, the push-pull signal generation unit 104 generates a push-pull signal from the voltage information inputted from the optical pickup unit 103, and outputs the generated push-pull signal to the tracking polarity determination unit 101. The push-pull signal is a signal used to detect the displacement of the center of the laser spot from the center of the groove, and also a signal used for the tracking control that compensates e.g., the variation in the reflection factor of the optical disc 102.

The tracking polarity determination unit 101 determines the tracking polarity of the optical disc 102 based on the push-pull signal inputted from the push-pull signal generation unit 104. The tracking polarity determination unit 101, after determining the tracking polarity, outputs the push-pull signal to the servo filter 109 along with the information of the determined tracking polarity.

Specifically, the binarized wobble signal generation unit 105 generates a wobble signal from the push-pull signal inputted from the push-pull signal generator 104, then generates a binarized wobble signal from the wobble signal. The binarized wobble signal generation unit 105 then outputs the generated binarized wobble signal to the characteristic quantity measurement unit 106. The wobble signal is a signal in which the push-pull signal varies with the wobbling period of the groove.

The characteristic quantity measurement unit 106 measures the characteristic quantity of the inputted binarized wobble signal, and outputs the measured characteristic quantity to the determination unit 107 where the characteristic quantity is, for example, the period, or the duty of the binarized wobble signal.

The determination unit 107 determines whether the measured characteristic quantity indicates a predetermined characteristic defined by the standard of the optical disc 102. The determination unit 107 outputs the determined result to the polarity determination unit 108, the determined result showing whether the measured characteristic quantity indicates the predetermined characteristic.

The polarity determination unit 108 identifies the polarity of the push-pull signal from the determined result inputted from the determination unit 107, and determines the tracking polarity based on the polarity of the push-pull signal. In addition, the polarity determination unit 108 outputs the push-pull signal inputted from the push-pull signal generation unit 104 to the servo filter 109 along with the information of the determined tracking polarity.

The servo filter 109 outputs a signal (feedback signal) to the drive unit 111 based on the information of the tracking polarity and the push-pull signal inputted by the tracking polarity determination unit 101 so that the drive unit 111 performs tracking control with the signal.

The drive unit 111 performs tracking control over the optical pickup unit 103 according to the inputted feedback signal.

In the above manner, the configuration of the optical disc reproducing device 100 is defined.

Next, the distinctive feature of the optical disc reproducing device 100, i.e., the operation thereof when the tracking polarity determination unit 101 determines the tracking polarity is described. The description related to a portion of the operation in the same manner as the conventional counterpart is omitted.

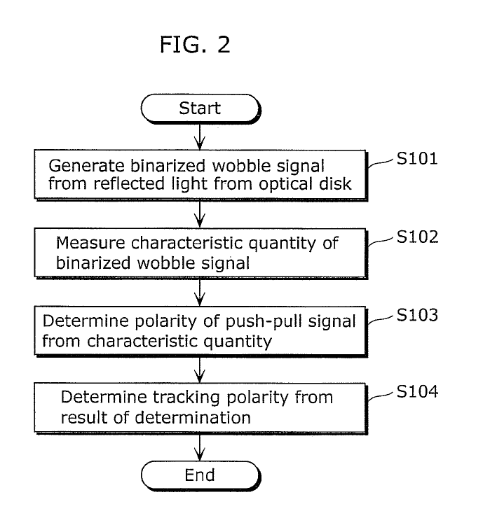

FIG. 2 is a flowchart for illustrating the operation of the tracking polarity determination unit in the present invention.

First, the binarized wobble signal generation unit 105 generates a binarized wobble signal from the push-pull signal which has been generated from the reflected beam of the optical disc 102 by the push-pull signal generation unit 104 (S101), and outputs the generated binarized wobble signal to the characteristic quantity measurement unit 106.

Next, the characteristic quantity measurement unit 106 measures the characteristic quantity of the inputted binarized wobble signal (S102), and outputs the measured characteristic quantity to the determination unit 107.

The determination unit 107 then determines whether the measured characteristic quantity indicates a predetermined characteristic defined by the standard of the optical disc 102, and outputs the determined result to the polarity determination unit 108, the determined result showing whether the measured characteristic quantity indicates the predetermined characteristic.

The polarity determination unit 108 identifies the polarity of the push-pull signal from the identified result inputted from the determination unit 107 (S103), and determines the tracking polarity based on the identified polarity of the push-pull signal (S104).

In the above manner, the tracking polarity determination unit 101 determines the tracking polarity.

As described above, in the present invention, only a single measurement of the binarized wobble signal of the track currently being scanned allows the recording system of the optical disc 102 to be identified as the on-groove system or the in-groove system.

### EMBODIMENT 1

In the following Embodiments 1, a specific example of characteristic quantity of the binarized wobble signal is described. Embodiment 1 is one of the embodiments in the present invention.

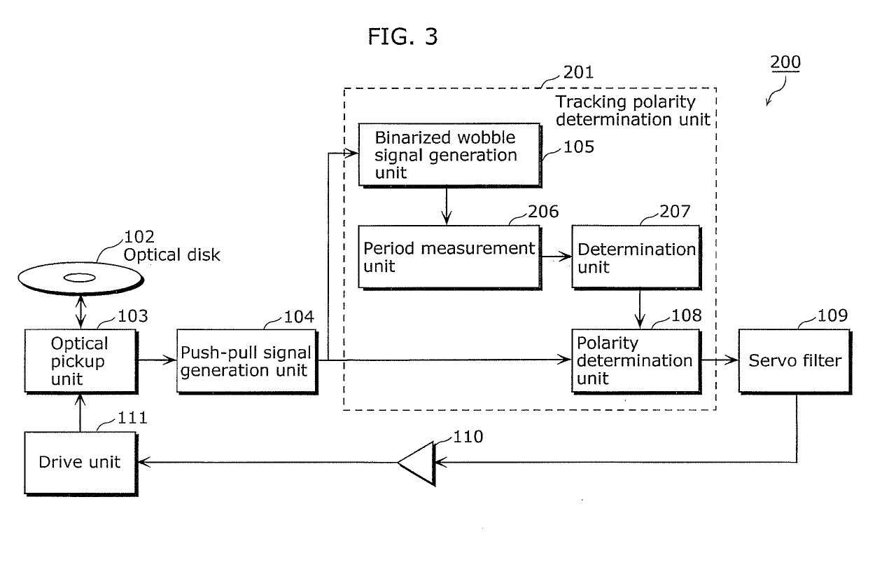

FIG. 3 is a block diagram showing the configuration of an optical disc reproducing device for identifying the recording system of an optical disc, in Embodiment 1.

An optical disc reproducing device 200 shown in FIG. 3 includes the optical disc 102, the optical pickup unit 103, the push-pull signal generation unit 104, the servo filter 109, the drive unit 111, and a tracking polarity determination unit 201. Also, the tracking polarity determination unit 201 includes the binarized wobble signal generation unit 105, the polarity determination unit 108, a period measurement unit 206, and a determination unit 207. The components similar to those in FIG. 1 are labeled with the same reference symbols as used in FIG. 1, and detailed description is omitted.

The optical disc reproducing device 200 shown in FIG. 3 is an embodiment of the configuration of the tracking polarity determination unit 101 of the optical disc reproducing device 100 shown in FIG. 1. Specifically, the characteristic quantity measurement unit 106 and the determination unit 107 in the tracking polarity determination unit 101 are embodied as the period measurement portion 206 and the determination unit 207 in the tracking polarity determination unit 201.

The period measurement unit 206 measures the period of the binarized wobble signal inputted by the binarized wobble signal generation unit 105, and outputs the measured period to the determination unit 207. The period of the binarized wobble signal corresponds to the above-described characteristic quantity of the binarized wobble signal.

The determination unit 207 determines whether or not the measured period is the period defined by the standard of the optical disc 102. The determination unit 207 then outputs the determined result to the polarity determination unit 108, the determined result showing whether or not the measured period indicates a predetermined characteristic, i.e., the period defined by the standard of the optical disc 102.

In the above manner, the configuration of the optical disc reproducing device 200 is defined.

Next, the method for the tracking polarity determination unit 201 to determine the polarity of the push-pull signal, i.e., the method for determining the recording system of the optical disc 102 as the on-groove system or the in-groove system is described by showing an example.

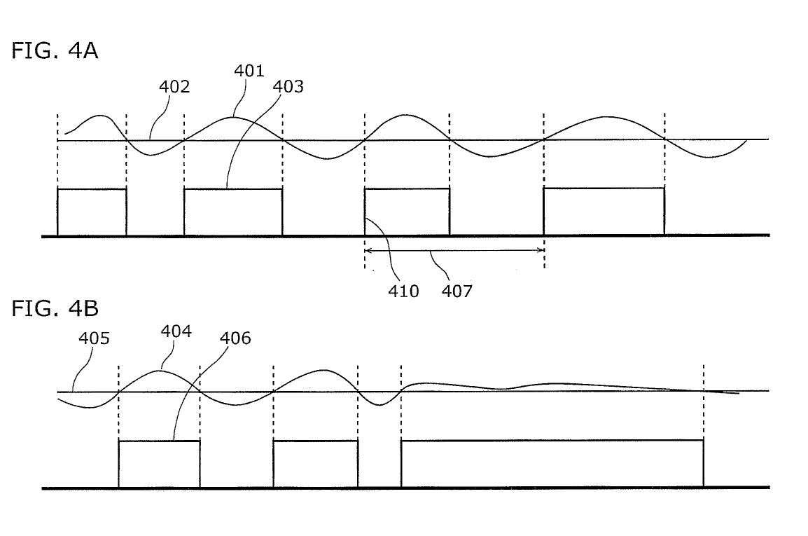

FIGS. 4A and 4B are diagrams for illustrating a method of determining whether the characteristic quantity of a binarized wobble signal indicates a predetermined characteristic quantity.

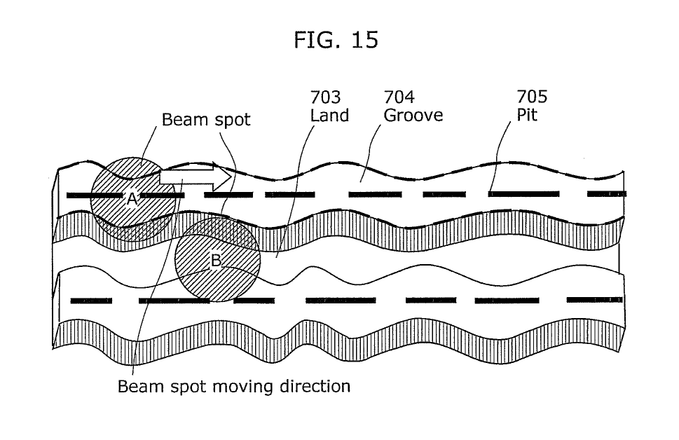

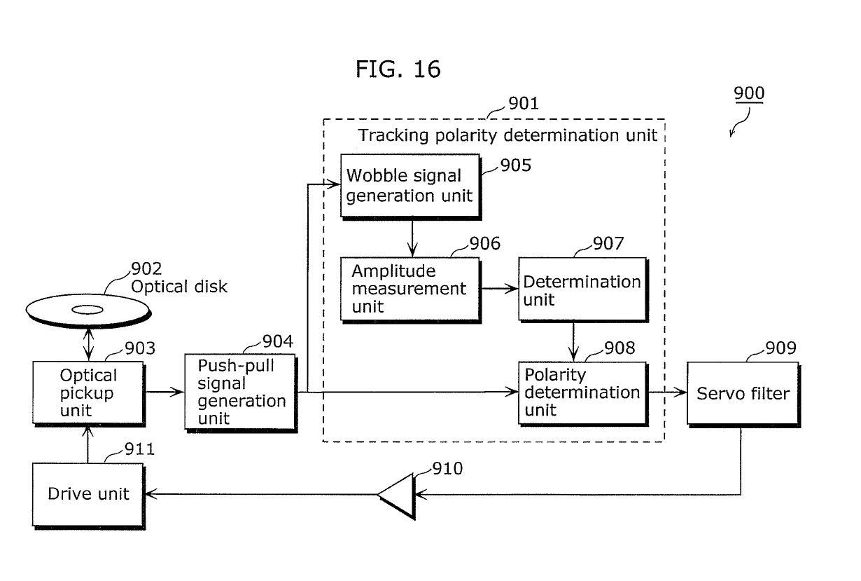

Now, a description is given using FIG. 15, assuming that the recording system of the optical disc 102 is the on-groove system.

FIG. 4A shows a wobble signal 401 and a binarized wobble signal 403 where the wobble signal 401 can be obtained when scanning the beam spot A along the track of the groove 704 in which the pit 705 is formed in FIG. 15, and the binarized wobble signal 403 is the resultant signal after the obtained wobble signal 401 is binarized based on a threshold value 402. Also, FIG. 4B shows a wobble signal 404 and a binarized wobble signal 406 where the wobble signal 404 can be obtained when scanning the beam spot B along with the track of the land 703 in FIG. 15, and the binarized wobble signal 406 is the resultant signal after the obtained wobble signal 404 is binarized based on a threshold value 405.

As shown in FIG. 4A, the binarized wobble signal 403 obtained from the beam spot A scanning the track of the groove 704 has a predetermined period 407, and repeats rising and falling in the period defined by, for example, the standard of the optical disc 102. The period herein indicates the time from a rising edge 410 to the subsequent rising edge 410 in the binarized wobble signal 403 as shown in FIG. 4A.

On the other hand, unlike the binarized wobble signal 403 from the groove 704, the binarized wobble signal 406 obtained from the beam spot B scanning the track of the land 703 repeats rising and falling in various periods as shown in FIG. 4B.

Therefore, by utilizing this characteristics, whether the track currently being scanned is the groove 704 or the land 703 can be determined from the result of measured periods of the binarized wobble signal of the track. That is to say, only a single measurement of the binarized wobble signal of the track currently being scanned allows the recording system of the optical disc 102 to be identified as the on-groove system or the in-groove system.

Next, the distinctive feature of the optical disc reproducing device 200, i.e., the operation thereof when the tracking polarity determination unit 201 determines the tracking polarity is described. The description related to a portion of the operation in the same manner as the conventional counterpart is omitted.

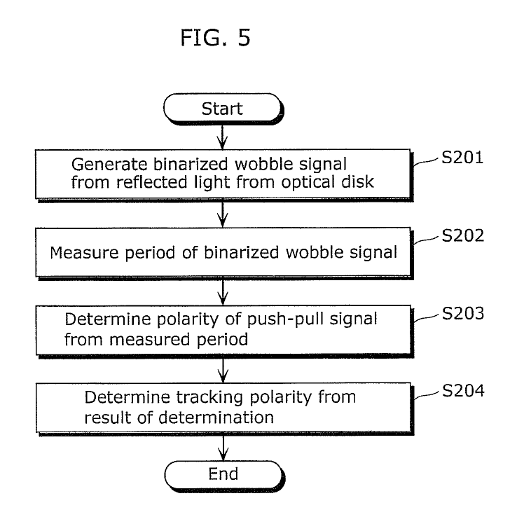

FIG. 5 is a flowchart for illustrating the operation of the tracking polarity determination unit in Embodiment 1.

First, the binarized wobble signal generation unit 105 generates a binarized wobble signal from the push-pull signal which has been generated from the reflected beam of the optical disc 102 by the push-pull signal generation unit 104 (S201), and outputs the generated binarized wobble signal to the period measurement unit 206.

Next, the period measurement unit 206 measures the period of the inputted binarized wobble signal (S202), and outputs the measured period to the determination unit 207.

The determination unit 207 then determines whether or not the measured period is the period defined by the standard of the optical disc 102. The determination unit 207 then outputs the determined result to the polarity determination unit 108, the determined result showing whether or not the measured period indicates a predetermined characteristic, i.e., the period defined by the standard of the optical disc 102.

Next, the polarity determination unit 108 identifies the polarity of the push-pull signal from the determined result inputted from the determination unit 207 (S203), and determines the tracking polarity based on the identified polarity of the push-pull signal (S204).

In the above manner, the tracking polarity determination unit 201 determines the tracking polarity.

As described above, according to Embodiment 1, only a single measurement of the binarized wobble signal of the track currently being scanned allows the recording system of the optical disc 102 to be identified as the on-groove system or the in-groove system. Thereby, an optical disc reproducing device that can reduce the time taken to identify the recording system of an optical disc can be achieved.

The above-mentioned push-pull signal may be generated by an analog signal as an output signal from the optical pickup unit 103, or may be generated by digital computation after the output signal from the optical pickup unit 103 is digitally converted by an ADC (Analog to Digital Converter).

Also, in the stage preceding the block of the binarized wobble signal generation unit 105, band limitation processing of signal may be performed by a BPF (band pass filter). In this case, a binarized wobble signal is generated based on the signal that has passed through the BPF. Thereby, a binarized wobble signal with higher precision can be generated.

### EMBODIMENT 2

In the following Embodiments 2, another specific example of characteristic quantity of the binarized wobble signal is described. Embodiment 2 is one of the embodiments in the present invention.

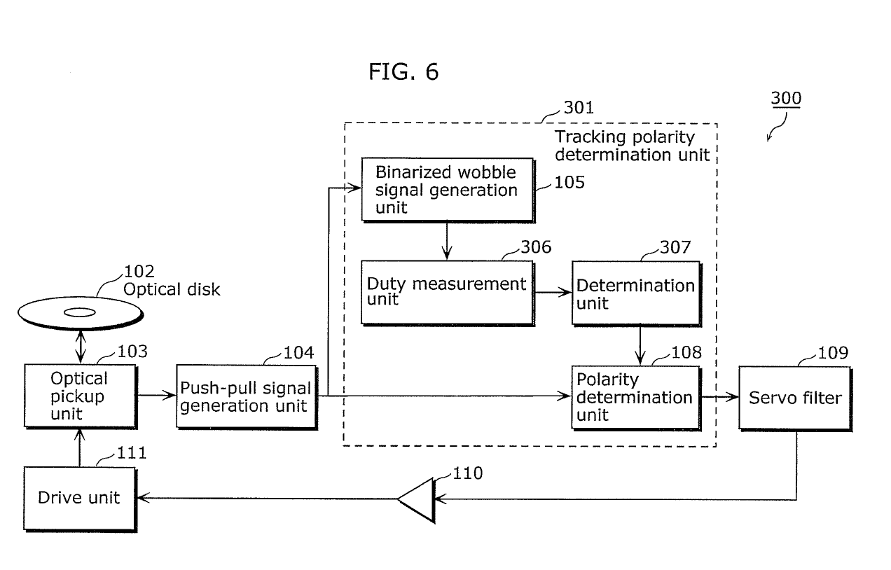

FIG. 6 is a block diagram showing the configuration of an optical disc reproducing device for identifying the recording system of an optical disc, in Embodiment 2.

An optical disc reproducing device 300 shown in FIG. 6 includes the optical disc 102, the optical pickup unit 103, the push-pull signal generation unit 104, the servo filter 109, the drive unit 111, and a tracking polarity determination unit 301. Also, the tracking polarity determination unit 301 includes the binarized wobble signal generation unit 105, the polarity determination unit 108, a duty measurement unit 306, and a determination unit 307. The components similar to those in FIGS. 1 and 3 are labeled with the same reference symbols as used in the figures, and detailed description is omitted.

The optical disc reproducing device 300 shown in FIG. 6 is an embodiment of the configuration of the tracking polarity determination unit 101 of the optical disc reproducing device 100 shown in FIG. 1. Specifically, the characteristic quantity measurement unit 106 and the determination unit 107 in the tracking polarity determination unit 101 are embodied as the duty measurement unit 306 and the determination unit 307 in the tracking polarity determination unit 301.

The duty measurement unit 306 measures the duty of the binarized wobble signal inputted by the binarized wobble signal generation unit 105, and outputs the measured duty to the determination unit 307. The duty of the binarized wobble signal corresponds to the above-described characteristic quantity of the binarized wobble signal, and indicates the ratio between the time interval during which the binarized wobble signal has a high-level value (H interval) and the time interval during which the binarized wobble signal has a low-level value (L interval) in a predetermined period.

The determination unit 307 determines whether or not the measured duty is the duty defined by the standard of the optical disc 102. The determination unit 307 then outputs the determined result to the polarity determination unit 108, the determined result showing whether or not the measured duty indicates a predetermined characteristic, i.e., the duty defined by the standard of the optical disc 102.

In the above manner, the configuration of the optical disc reproducing device 300 is defined.

Next, the method for the tracking polarity determination unit 301 to determine the polarity of the push-pull signal, i.e., the method for determining the recording system of the optical disc 102 as the on-groove system or the in-groove system is described by showing an example.

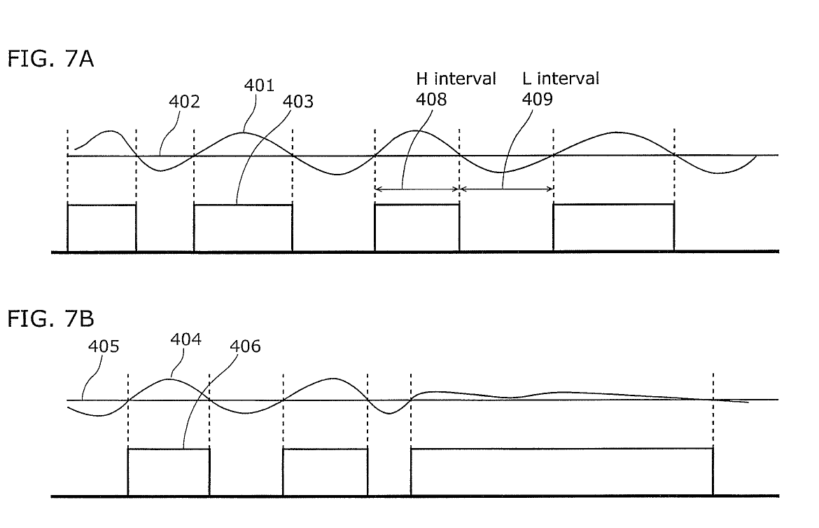

FIGS. 7A and 7B are diagrams for illustrating the method of determining whether the characteristic quantity of a binarized wobble signal indicates a predetermined characteristic quantity.

Now, a description is given using FIG. 15, assuming that the recording system of the optical disc 102 is the on-groove system. The components similar to those in FIGS. 4A and 4B are labeled with the same reference symbols as used in the figures.

Similarly to FIG. 4A, FIG. 7A shows the wobble signal 401 and the binarized wobble signal 403 where the wobble signal 401 can be obtained when scanning the beam spot A along the track of the groove 704 in which the pit 705 is formed in FIG. 15, and the binarized wobble signal 403 is the resultant signal after the obtained wobble signal 401 is binarized based on the threshold value 402. Similarly to FIG. 4B, FIG. 7B shows the wobble signal 404 and the binarized wobble signal 406 where the wobble signal 404 can be obtained when scanning the beam spot B along with the track of the land 703 in FIG. 15, and the binarized wobble signal 406 is the resultant signal after the obtained wobble signal 404 is binarized based on the threshold value 405.

As shown in FIG. 7A, the binarized wobble signal 403 obtained from the beam spot A scanning the track of the groove 704 has a predetermined duty, and repeats rising and falling so as to yield the duty defined by, for example, the standard of the optical disc 102. The duty herein indicates the ratio between H interval 408 and L interval 409 of the binarized wobble signal as shown in FIG. 7A.

On the other hand, unlike the binarized wobble signal 403 from the groove 704, the binarized wobble signal 406 obtained from the beam spot B scanning the track of the land 703 repeats rising and falling with various duties as shown in FIG. 7B.

Therefore, by utilizing this characteristics, whether the track currently being scanned is on the groove 704 or the land 703 can be determined from the result of measured duties of the binarized wobble signal of the track. That is to say, whether the recording system of the optical disc 102 is the on-groove system or the in-groove system can be determined based on a predetermined characteristic quantity.

Next, the distinctive feature of the optical disc reproducing device 300, i.e., the operation thereof when the tracking polarity determination unit 301 determines the tracking polarity is described. The description related to a portion of the operation in the same manner as the conventional counterpart is omitted.

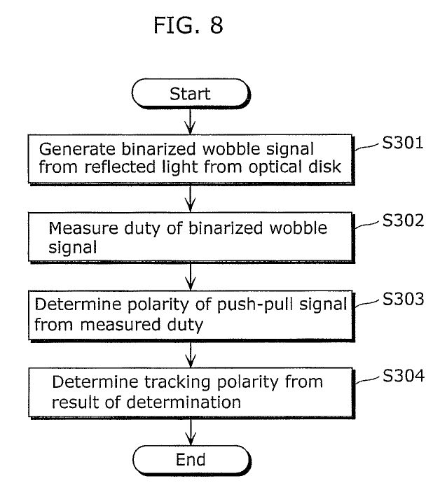

FIG. 8 is a flowchart for illustrating the operation of a tracking polarity determination unit in Embodiment 2.

First, the binarized wobble signal generation unit 105 generates a binarized wobble signal from the push-pull signal which has been generated from the reflected beam of the optical disc 102 by the push-pull signal generation unit 104 (S301), and outputs the generated binarized wobble signal to the duty measurement unit 306.

Next, the duty measurement unit 306 measures the duty of the inputted binarized wobble signal (S202), and outputs the measured duty to the determination unit 307.

The determination unit 307 then determines whether or not the measured duty is the duty defined by the standard of the optical disc 102. The determination unit 307 then outputs the determined result to the polarity determination unit 108, the determined result showing whether or not the measured duty indicates a predetermined characteristic, i.e., the duty defined by the standard of the optical disc 102.

Next, the polarity determination unit 108 identifies the polarity of the push-pull signal from the determined result inputted from the determination unit 307 (S303), and determines the tracking polarity based on the identified polarity of the push-pull signal (S304).

In the above manner, the tracking polarity determination unit 301 determines the tracking polarity.

As described above, according to Embodiment 2, only a single measurement of the binarized wobble signal of the track currently being scanned allows the recording system of the optical disc 102 to be identified as the on-groove system or the in-groove system. Thereby, an optical disc reproducing device that can reduce the time taken to identify the recording system of an optical disc can be achieved.

The above-mentioned push-pull signal may be generated by an analog signal as an output signal from the optical pickup unit 103, or may be generated by digital computation after the output signal from the optical pickup unit 103 is digitally converted by an ADC (Analog to Digital Converter).

Also, in the stage preceding the block of the binarized wobble signal generation unit 105, band limitation processing of signal may be performed by a BPF (band pass filter). In this case, a binarized wobble signal is generated based on the signal that has passed through the BPF. Thereby, a binarized wobble signal with higher precision can be generated.

### EMBODIMENT 3

In the following Embodiments 3, another specific example of characteristic quantity of the binarized wobble signal is described. Embodiment 3 is one of the embodiments in the present invention.

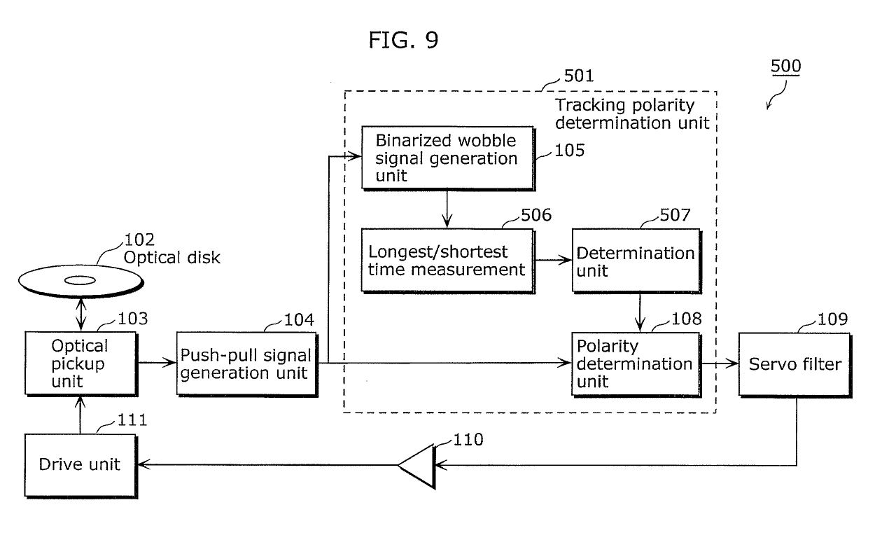

FIG. 9 is a block diagram showing the configuration of an optical disc reproducing device for identifying the recording system of an optical disc, in Embodiment 3.

An optical disc reproducing device 500 shown in FIG. 9 includes the optical disc 102, the optical pickup unit 103, the push-pull signal generation unit 104, the servo filter 109, the drive unit 111, and a tracking polarity determination unit 501. Also, the tracking polarity determination unit 501 includes the binarized wobble signal generation unit 105, the polarity determination unit 108, a longest/shortest time measurement unit 506, and a determination unit 307. The components similar to those in FIGS. 1, 3, and 6 are labeled with the same reference symbols as used in the figures, and detailed description is omitted.

The optical disc reproducing device 500 shown in FIG. 9 is an embodiment of the configuration of the tracking polarity determination unit 101 of the optical disc reproducing device 100 shown in FIG. 1. Specifically, the characteristic quantity measurement unit 106 and the determination unit 107 in the tracking polarity determination unit 101 are embodied as the longest/shortest time measurement unit 506 and the determination unit 507 in the tracking polarity determination unit 501.

The longest/shortest time measurement unit 506 measures the longest time interval or the shortest time interval during which the binarized wobble signal inputted by the binarized wobble signal generation unit 105 has a high-level value (or low-level value), and outputs the longest time interval or the shortest time interval to the determination unit 507. The longest time and the shortest time of the binarized wobble signal correspond to the characteristic quantity of the binarized wobble signal.

The determination unit 507 determines whether the measured longest time or shortest time falls within the predetermined range defined by the standard of the optical disc 102. The determination unit 507 then outputs the determined result to the polarity determination unit 108, the determined result showing whether or not the measured longest time or shortest time indicates a predetermined characteristic, i.e., the time falls within the predetermined range defined by the standard of the optical disc 102.

In the above manner, the configuration of the optical disc reproducing device 500 is defined.

Next, the method for the tracking polarity determination unit 501 to determine the polarity of the push-pull signal, i.e., the method for determining the recording system of the optical disc 102 as the on-groove system or the in-groove system is described by showing an example.

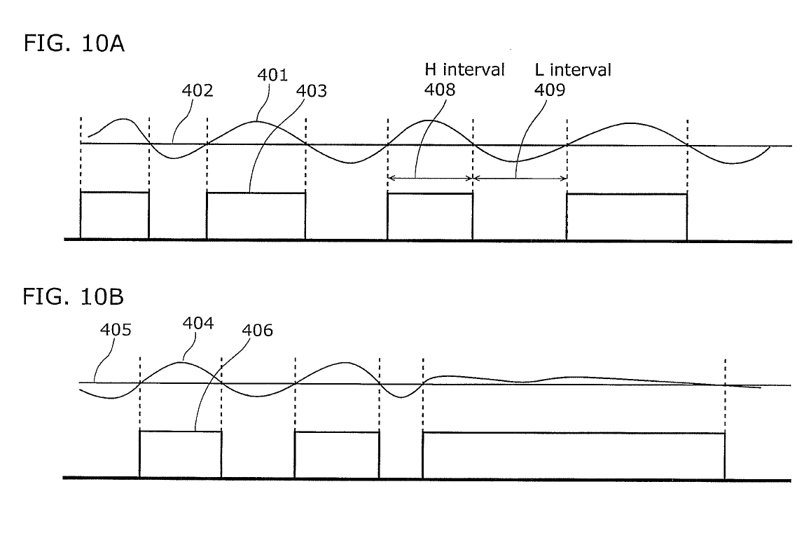

FIGS. 10A and 10B are diagrams for illustrating the method of determining whether the characteristic quantity of a binarized wobble signal indicates a predetermined characteristic quantity.

Now, a description is given using FIG. 15, assuming that the recording system of the optical disc 102 is the on-groove system. The components similar to those in FIGS. 4A, 4B, 7A, and 7B are labeled with the same reference symbols as used in the figures, and description is omitted.

As shown in FIG. 10A, the binarized wobble signal 403 obtained from the beam spot A scanning the track of the groove 704 repeats the longest time interval and the shortest time interval corresponding to a high-level value (or low-level value) with the time interval defined by, for example, the standard of the optical disc 102.

On the other hand, the binarized wobble signal 406 obtained from the beam spot B scanning the track of the land 703 repeats various time intervals without showing the longest time interval and the shortest time interval within a predetermined range as described above. That is to say, unlike the binarized wobble signal 403 from the groove 704, the length of the H interval and the L interval take various values where the H interval shows a time interval on which the binarized wobble signal has a high-level value and the L interval shows a time interval on which the binarized wobble signal has a low-level value.

Therefore, by utilizing this characteristics, whether the track currently being scanned is on the groove 704 or the land 703 can be determined from the result of the measured longest time or shortest time corresponding to a high-level value (a low-level value) of the binarized wobble signal of the track. That is to say, whether the recording system of the optical disc 102 is the on-groove system or the in-groove system can be determined based on a predetermined characteristic quantity.

The operation of the tracking polarity determination unit 501 for determining the tracking polarity is similar to the operation in FIG. 8, thus a description is omitted.

As described above, according to Embodiment 3, only a single measurement of the binarized wobble signal of the track currently being scanned allows the recording system of the optical disc 102 to be identified as the on-groove system or the in-groove system. Thereby, an optical disc reproducing device that can reduce the time taken to identify the recording system of an optical disc can be achieved.

The above-mentioned push-pull signal may be generated by an analog signal as an output signal from the optical pickup unit 103, or may be generated by digital computation after the output signal from the optical pickup unit 103 is digitally converted by an ADC (Analog to Digital Converter).

Also, in the stage preceding the block of the binarized wobble signal generation unit 105, band limitation processing of signal may be performed by a BPF (band pass filter). In this case, a binarized wobble signal is generated based on the signal which passed BPF. Thereby, a binarized wobble signal with higher precision can be generated.

### EMBODIMENT 4

In the following Embodiments 4, another specific example of characteristic quantity of the binarized wobble signal is described. Embodiment 4 is one of the embodiments in the present invention.

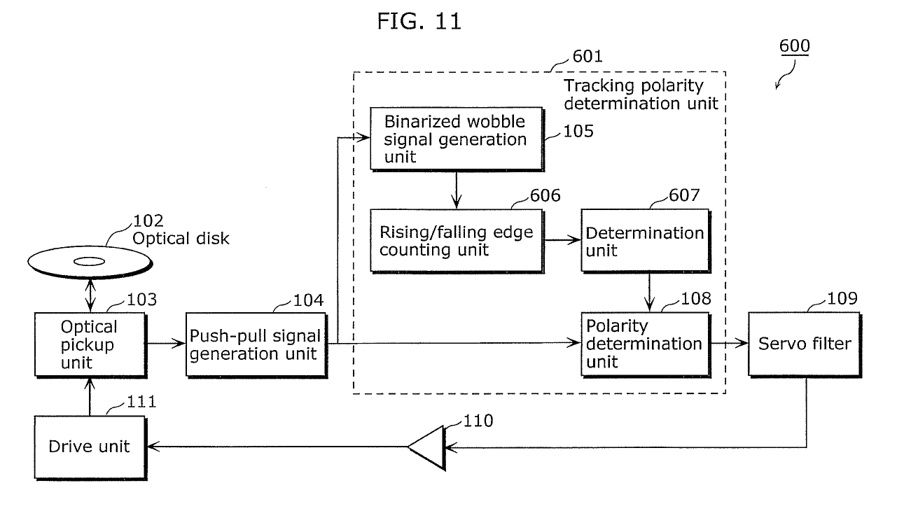

FIG. 11 is a block diagram showing the configuration of an optical disc reproducing device for identifying the recording system of an optical disc, in Embodiment 4.

An optical disc reproducing device 600 shown in FIG. 11 includes the optical disc 102, the optical pickup unit 103, the push-pull signal generation unit 104, the servo filter 109, the drive unit 111, and a tracking polarity determination unit 601. Also, the tracking polarity determination unit 601 includes the binarized wobble signal generation unit 105, the polarity determination unit 108, a rising/falling edge counting unit 606, and a determination unit 607. The components similar to those in FIGS. 1, 3, 6, and 9 are labeled with the same reference symbols as used in the figures, and detailed description is omitted.

The optical disc reproducing device 600 shown in FIG. 11 is an embodiment of the configuration of the tracking polarity determination unit 101 of the optical disc reproducing device 100 shown in FIG. 1. Specifically, the characteristic quantity measurement unit 106 and the determination unit 107 in the tracking polarity determination unit 101 are embodied as the rising/falling edge counting unit 606 and the determination unit 607 in the tracking polarity determination unit 601.

The rising/falling edge counting unit 606 measures the number of rising or falling edges of the binarized wobble signal inputted by the binarized wobble signal generation unit 105, and outputs the measured number of rising or falling edges to the determination unit 607. The number of rising or falling edges of the binarized wobble signal correspond to the characteristic quantity of the binarized wobble signal. The rising edge means the moment when the binarized wobble signal changes to a high-level value, and the falling edge means the moment when the binarized wobble signal changes to a low-level value.

The determination unit 607 determines whether the measured number of rising or falling edges falls within the predetermined range defined by the standard of the optical disc 102. The determination unit 607 then outputs the determined result to the polarity determination unit 108, the determined result showing whether or not the measured number of rising or falling edges indicates a predetermined characteristic, i.e., the number falls within the predetermined range defined by the standard of the optical disc 102.

In the above manner, the configuration of the optical disc reproducing device 600 is defined.

Next, the method for the tracking polarity determination unit 601 to determine the polarity of the push-pull signal, i.e., the method for determining the recording system of the optical disc 102 as the on-groove system or the in-groove system is described by showing an example.

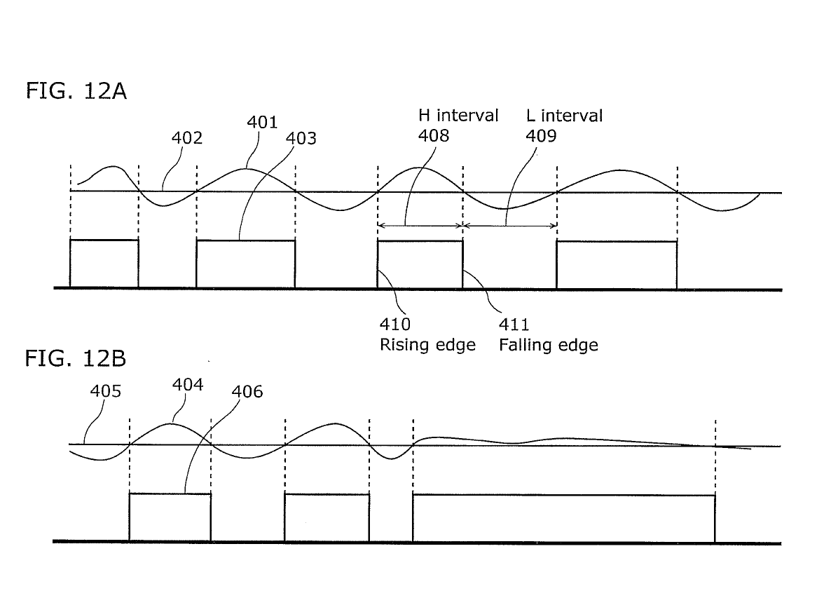

FIGS. 12A and 12B are diagrams for illustrating the method of determining whether the characteristic quantity of a binarized wobble signal indicates a predetermined characteristic quantity.

Now, a description is given using FIG. 15, assuming that the recording system of the optical disc 102 is the on-groove system. The components similar to those in FIGS. 4A, 4B, 7A, 7B, 10A, and 10B are labeled with the same reference symbols as used in the figures, and description is omitted.

As shown in FIG. 12A, the binarized wobble signal 403 obtained from the beam spot A scanning the track of the groove 704 repeats H interval 408 and L interval 409 with the respective lengths defined by, for example, the standard of the optical disc 102. Therefore, the number of rising edge 410 and the number of falling edge 411 in an arbitrary time interval fall within a predetermined range.

On the other hand, unlike the binarized wobble signal 403 from the groove 704, the binarized wobble signal 406 obtained from the beam spot B scanning the track of the land 703 repeats H interval 408 and L interval 409 as shown in FIG. 12B. Therefore, the number of rising edge 410 and the number of falling edge 411 in an arbitrary time interval do not fall within a predetermined range.

Therefore, by utilizing this characteristics, whether the track currently being scanned is on the groove 704 or the land 703 can be determined from the result of the measured number of rising edge and the measured number of falling edges of the binarized wobble signal within a certain time interval in the signal of the track. That is to say, only a single measurement of the binarized wobble signal of the track currently being scanned allows the recording system of the optical disc 102 to be identified as the on-groove system or the in-groove system.

The operation of the tracking polarity determination unit 601 for determining the tracking polarity is similar to the operation in FIG. 8, thus a description is omitted.

As described above, according to Embodiment 4, the measurement of the number of rising edge and the number of falling edges of the binarized wobble signal in the track currently being scanned, within a certain time interval, i.e., only a single measurement of the binarized wobble signal allows the recording system of the optical disc 102 to be identified as the on-groove system or the in-groove system. Thereby, an optical disc reproducing device that can reduce the time taken to identify the recording system of an optical disc can be achieved.

The above-mentioned push-pull signal may be generated by an analog signal as an output signal from the optical pickup unit 103, or may be generated by digital computation after the output signal from the optical pickup unit 103 is digitally converted by an ADC (Analog to Digital Converter).

Also, in the stage preceding the block of the binarized wobble signal generation unit 105, band limitation processing of signal may be performed by a BPF (band pass filter). In this case, a binarized wobble signal is generated based on the signal which passed BPF. Thereby, a binarized wobble signal with higher precision can be generated.

### EMBODIMENT 5

In Embodiment 5, an exemplary case is described where at least one of the characteristic quantities of the binarized wobble signal explained in Embodiments 1 to 4 can be selectively measured. Embodiment 5 is one of the embodiments in the present invention.

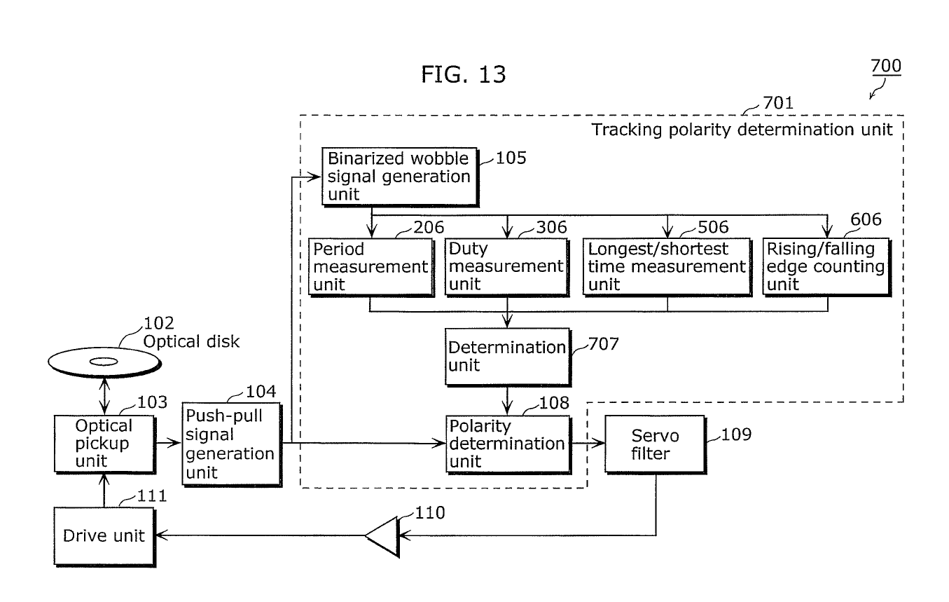

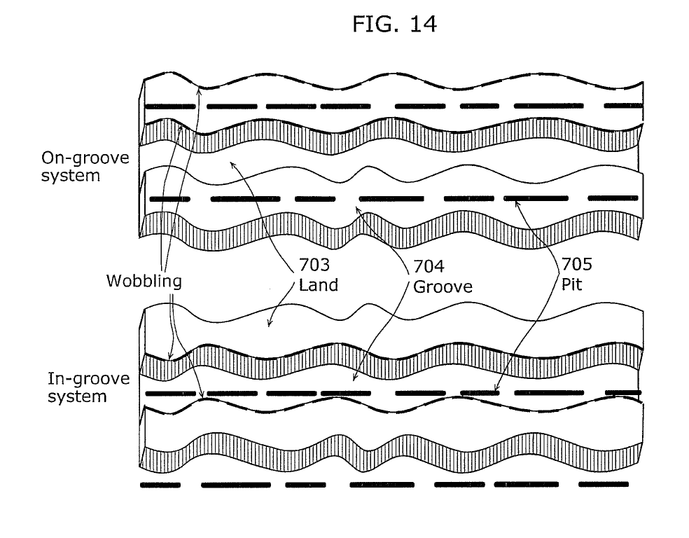

FIG. 13 is a block diagram showing the configuration of an optical disc reproducing device for identifying the recording system of an optical disc, in Embodiment 5.

An optical disc reproducing device 700 shown in FIG. 13 includes the optical disc 102, the optical pickup unit 103, the push-pull signal generation unit 104, the servo filter 109, the drive unit 111, and a tracking polarity determination unit 701. Also, the tracking polarity determination unit 701 includes the binarized wobble signal generation unit 105, the polarity determination unit 108, the period measurement unit 206, the duty measurement unit 306, the longest/shortest time measurement unit 506, the rising/falling edge counting unit 606, and a determination unit 707. The components similar to those in FIGS. 1, 3, 6, 9, and 11 are labeled with the same reference symbols as used in the figures, and detailed description is omitted. The optical disc reproducing device 700 shown in FIG. 13 is an embodiment of the configuration of the tracking polarity determination unit 101 of the optical disc reproducing device 100 shown in FIG. 1.

In the tracking polarity determination unit 701, a binarized wobble signal is inputted by the binarized wobble signal generation unit 105 to each of the period measurement unit 206, the duty measurement unit 306, the longest/shortest time measurement unit 506, the rising/falling edge counting unit 606. The period measurement unit 206 measures the period of the inputted binarized wobble signal, and the duty measurement unit 306 measures the duty of the inputted binarized wobble signal. The longest/shortest time measurement unit 506 measures the longest time interval or the shortest time interval of the inputted binarized wobble signal, and the rising/falling edge counting unit 606 measures the number of rising or falling edges of the inputted binarized wobble signal.

The determination unit 707 determines whether the measured period falls within a predetermined range, whether the measured duty falls within a predetermined range, whether the measured longest or shortest time interval falls within a predetermined range, and whether the measured number of rising or falling edges falls within a predetermined range.

Also, the polarity determination unit 108 identifies the polarity of the push-pull signal from the identified result inputted from the determination unit 707, and determines the tracking polarity based on the identified polarity of the push-pull signal.

In FIG. 13, four quantities are used as the characteristic quantities extracted from the binarized wobble signal. However, one or two or more characteristic quantities may be selected from these characteristic quantities to be measured. In this case, the polarity of the push-pull signal is identified by the selected combination of characteristic quantities, and the tracking polarity is determined based on the identified polarity of the push-pull signal.

In the above manner, the configuration of the optical disc reproducing device 700 is defined.

The method for the tracking polarity determination unit 701 to determine the polarity of the push-pull signal, and the operation of the tracking polarity determination unit 701 for determining the tracking polarity are similar to those described in Embodiments 1 to 4, thus a description is omitted.

As described above, according to Embodiment 5, only a single measurement of the binarized wobble signal allows the recording system of the optical disc 102 to be identified as the on-groove system or the in-groove system. Thereby, an optical disc reproducing device that can reduce the time taken to identify the recording system of an optical disc can be achieved.

The above-mentioned push-pull signal may be generated by an analog signal as an output signal from the optical pickup unit 103, or may be generated by digital computation after the output signal from the optical pickup unit 103 is digitally converted by an ADC (Analog to Digital Converter).

Also, in the stage preceding the block of the binarized wobble signal generation unit 105, band limitation processing of signal may be performed by a BPF (band pass filter). In this case, a binarized wobble signal is generated based on the signal which passed BPF. Thereby, a binarized wobble signal with higher precision can be generated.

As described above, according to the present invention, a signal processing circuit and an optical disc reproducing device that can reduce the time taken to identify the recording system of an optical disc can be achieved.

Although the optical disc reproducing device of the present invention has been described in the above based on the embodiments, the present invention is not limited to these embodiments. As long as not departing from the spirit of the present invention, various modifications made to the present embodiment by those skilled in the art, and embodiment which is constructed by combining the components in different embodiments are also included in the scope of the present embodiment.

For example, an optical disc reproducing device, even when having recording means for recording information (data) on an optical disc, is within the spirit of the present invention, and is included in the scope of the present embodiment.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be used for a signal processing circuit and an optical disc reproducing device, and particularly, can be used for identifying the recording system of an optical disc reproducing device.

What is claimed is:

1. A signal processing circuit comprising
a tracking polarity determination unit configured to determine a polarity when tracking control is performed on an optical disc having a groove track and a land track, on which a frequency-modulated or phase-modulated wobble is formed to indicate address information on the groove track in which data is recorded,
said tracking polarity determination unit including:
a binarized wobble signal generation unit configured to generate a wobble signal according to a shape of the wobble, and to generate a binarized wobble signal based on whether or not a value of the wobble signal exceeds a threshold value;
a characteristic quantity measurement unit configured to measure a characteristic quantity of the binarized wobble signal generated by said binarized wobble signal generation unit;
a determination unit configured to determine whether or not the characteristic quantity of the binarized wobble signal measured by said characteristic quantity measurement unit indicates a predetermined characteristic; and
a polarity determination unit configured to determine the polarity by a result of the determination by said determination unit.

2. The signal processing circuit according to claim 1,
wherein said characteristic quantity measurement unit is configured to measure a period of the binarized wobble signal, as the characteristic quantity of the binarized wobble signal.

3. The signal processing circuit according to claim 1,
wherein said characteristic quantity measurement unit is configured to measure a duty of the binarized wobble signal as the characteristic quantity of the binarized wobble signal, the duty being a ratio between a time interval during which the binarized wobble signal has a high-level value in a predetermined period and another time interval during which the binarized wobble signal has a low-level value in the predetermined period.

4. The signal processing circuit according to claim 1,
wherein said characteristic quantity measurement unit is configured to measure, as the characteristic quantity of the binarized wobble signal, a longest or a shortest time interval during which the binarized wobble signal has a high-level value within a predetermined time.

5. The signal processing circuit according to claim 1,
wherein said characteristic quantity measurement unit is configured to measure, as the characteristic quantity of the binarized wobble signal, a longest or a shortest time interval during which the binarized wobble signal has a low-level value within a predetermined time.

6. The signal processing circuit according to claim 1,
wherein said characteristic quantity measurement unit is configured to measure, as the characteristic quantity of the binarized wobble signal, the number of rising edge within a predetermined time or the number of falling edge within a predetermined time, the rising edge each indicating a moment when the binarized wobble signal changes to a high-level value, and the falling edge each indicating a moment when the binarized wobble signal changes to a low-level value.

7. An optical disc reproducing device comprising:
an optical pickup unit configured to read information needed to perform tracking control, from an optical disc having a groove track and a land track, on which a frequency-modulated or phase-modulated wobble is formed to indicate address information on the groove track in which data is recorded;
a tracking polarity determination unit configured to determine a polarity when tracking control is performed, from the information read by said optical pickup unit; and
a drive unit configured to perform tracking control of said optical pickup unit by a control signal generated based on the polarity of tracking control determined by said tracking polarity determination unit,
said tracking polarity determination unit including:
a binarized wobble signal generation unit configured to generate a wobble signal according to a shape of the wobble from the information read by said optical pickup unit, and to generate a binarized wobble signal based on whether or not the value of the wobble signal exceeds a threshold value;
a characteristic quantity measurement unit configured to measure a characteristic quantity of the binarized wobble signal generated by said binarized wobble signal generation unit;
a determination unit configured to determine whether or not the characteristic quantity of the binarized wobble signal measured by said characteristic quantity measurement unit indicates a predetermined characteristic; and
a polarity determination unit configured to determine the polarity by a result of the determination by said determination unit.

8. An optical disc reproducing device according to claim 7, wherein said characteristic quantity measurement unit is configured to measure a period of the binarized wobble signal, as the characteristic quantity of the binarized wobble signal.

9. The optical disc reproducing device according to claim 7, wherein said characteristic quantity measurement unit is configured to measure a duty of the binarized wobble signal as the characteristic quantity of the binarized wobble signal, the duty being a ratio between a time interval during which the binarized wobble signal has a high-level value in a predetermined period and another time interval during which the binarized wobble signal has a low-level value in the predetermined period.

10. The optical disc reproducing device according to claim 7, wherein said characteristic quantity measurement unit is configured to measure, as the characteristic quantity of the binarized wobble signal, a longest or a shortest time interval during which the binarized wobble signal has a high-level value within a predetermined time.

11. The optical disc reproducing device according to claim 7, wherein said characteristic quantity measurement unit is configured to measure, as the characteristic quantity of the binarized wobble signal, a longest or a shortest of time interval during which the binarized wobble signal has a low-level value within a predetermined time.

12. The optical disc reproducing device according to claim 7, wherein said characteristic quantity measurement unit is configured to measure, as the characteristic quantity of the binarized wobble signal, the number of rising edge within a predetermined time, the rising edge indicating a moment when the binarized wobble signal changes to a high-level value, or the number of falling edge within a predetermined time, the falling edge indicating a moment when the binarized wobble signal changes to a low-level value.

13. A method of processing a signal, performed by a tracking polarity determination unit to determine a polarity when tracking control is performed on an optical disc having a groove track and a land track, on which a frequency-modulated or phase-modulated wobble is formed to indicate address information on the groove track in which data is recorded, said method comprising:
generating a binarized wobble signal to generate a wobble signal according to a shape of the wobble, and to generate a binarized wobble signal based on whether or not the value of the wobble signal exceeds a threshold value;
measuring a characteristic quantity to measure a characteristic quantity of the binarized wobble signal generated in said generating; determining whether or not the characteristic quantity of the binarized wobble signal measured in said measuring indicates a predetermined characteristic; and
determining the polarity by a result of the determination in said determining whether or not the characteristic quantity indicates a predetermined characteristic.
